(19) United States
(12) Patent Application Publication
(10) Pub. No.: US 2011/0264638 A1
(43) Pub. Date: Oct. 27, 2011

(54) System and Method for Communicating Enterprise Information Between a Mobile Device and a Backend Platform

(75) Inventor: Sze Yuen Wong, Herndon, VA (US)

(73) Assignee: Zerion Software, Inc.

(21) Appl. No.: 12/766,502

(22) Filed: Apr. 23, 2010

(51) Int. Cl. G06F 17/30; G06F 15/16; G06F 7/00; G06F 17/21

(52) U.S. Cl. 707/705; 715/222; 709/230; 707/812; 707/803; 707/E17.044; 707/E17.032

(57) ABSTRACT

Various systems and methods for communicating enterprise information between an enterprise backend server and a mobile device are provided. For example, a middleware server may generate a formbuilder interface that allows a user to input form design information used to display a custom dynamic form. The form design information may include a plurality of form elements and an executable script that in part controls a behavior of the custom dynamic form. The custom dynamic form may be configured to prompt input of and receive the enterprise information. A value of a first one of the plurality of form elements may cause an action to be taken by the custom dynamic form, wherein the executable instruction when executed causes the action to be taken. The middleware server may communicate to the mobile device the plurality of form elements and the executable instruction. An operator of the mobile device may provide enterprise information using the custom dynamic form. The middleware server may receive, from the custom dynamic form, a plurality of values each entered used respective ones of the plurality of form elements. The plurality of values includes the enterprise information, and the plurality of form elements may include at least one value affected by the action to be taken by the form. The middleware server may communicate the plurality of values to the enterprise backend server.

### FIELD OF THE INVENTION

The disclosure relates to systems, devices, and methods for communicating enterprise information between a mobile device and a backend platform and more particularly to a mobile middleware platform that facilitates enterprise data collection using a mobile device.

### BACKGROUND OF THE INVENTION

Businesses (i.e., corporations, organizations, individuals, and/or other entities) routinely generate workflows and collect enterprise information as an important component of their operations. The workflows may include one or more questions to be answered and/or tasks to be performed. Enterprise information may include answers to the questions, status of the tasks to be performed, and/or other information collected by the business. For example, utility companies such as cable television providers generate work orders that inform technicians which customers require service and what service needs to be performed. Such utility companies also collect information from their technicians such as whether and when the service has been performed. Another example includes government entities that may generate lists of inspections to be performed at various building sites and collect inspection information from inspectors who conduct the inspections. Businesses may even generate survey questionnaires to elicit responses designed to understand how their customers and/or other individuals feel about a particular topic.

Existing workflow and data collection solutions typically use paper-based documentation methods, where a technician, for example, is given a paper listing of tasks to be performed and the technician documents the performed tasks using paper forms. Other solutions include using dedicated hardware devices that are highly specific to the business organization. In other words, the dedicated hardware devices are typically hard-coded to perform specific tasks for a specific business. For example, parcel delivery services may use package tracking devices that are typically dedicated to record when a package has been delivered. Such package tracking devices could not, for example, be used to track the cable technician's workflow.

Recent developments in mobile computing provide an opportunity to address drawbacks of existing systems. For example, smartphones, PDAs, tablet PCs, and other mobile devices enable mobile computing to handle increasingly complex tasks. Thus, what is needed is to be able to leverage the power of these mobile devices in order to, for example, generate forms to perform package tracking, cable television installations, and/or other enterprise information collection. However, one problem is that mobile devices typically have limited screen size and/or oftentimes limited connectivity (such as “spotty” or no cellular data coverage areas) to transfer data files. These limitations may be significant, given that forms to collect enterprise information may include large numbers of elements and/or complex interrelationships between the elements, which results in large amounts of information and/or complex combinations of information to be displayed and collected. For example, enterprise information may include a listing of possible answer choices to questions. In some implementations, the listing of possible answers may include several thousand predefined options that may be selected, only a few of which may be relevant for a particular portion of the custom dynamic form being displayed. Thus, efficiently displaying the possible answer choices is problematic.

Accordingly, mobile computing platforms currently fail to address the above and other problems. For instance, while application development on certain mobile devices is robust, these applications typically serve a limited purpose and are not extendable to handle different needs of different consumers, let alone collect enterprise information such as an inspection report or cable television installation.

Therefore, efficiently communicating large amounts of data to and from mobile devices that may have a potentially limited display size and limited number of data connections while addressing the disparate needs of different businesses may be problematic. These and other problems exist.

### SUMMARY OF THE INVENTION

Various systems, devices, and methods that facilitate communication of enterprise information between mobile devices and business computing platforms are provided. For example, various implementations of the invention include middleware systems that leverage advances in mobile device technology to communicate enterprise information between mobile devices and backend business computing platforms. In doing so, various implementations of the invention may be used to provide an out-of-the-box solution that is flexible and scalable to meet the data collection needs of various businesses.

In some implementations, a middleware server may generate a formbuilder interface that may be used to design a custom dynamic form that collects the enterprise information. A user of the formbuilder interface may enter form design information that is used to render the form at a mobile device. The form design information may include, among other things, form elements that collect the enterprise information, an executable script that may control the behavior of the form elements and/or the custom dynamic form, and/or other information used to render the custom dynamic form. Unlike conventional systems that constrain a designer to fixed operators and operands, by allowing a user of the formbuilder interface to input an executable script that may control behavior of the custom dynamic form, the middleware server provides businesses with a flexible platform by which to generate and manage forms.

In some implementations, the middleware server may store the form design information using an open data architecture, which may include generating one or more database tables to store the form design information. In this manner, the open data architecture facilitates flexible design of custom dynamic forms in order to accommodate different enterprise information for different businesses.

In some implementations, the middleware server may receive a request from a mobile device to receive one or more custom dynamic forms. In response to the request, the middleware server may identify the mobile device and/or user of the mobile device to determine which of the one or more custom dynamic forms (i.e., the form design information used to render the custom dynamic forms) is available for download (i.e., receipt) by the mobile device. In some implementations, the middleware server may notify the mobile device of the custom dynamic forms available for download by the mobile device. The mobile device may then perform a synchronization operation where custom dynamic forms that are available at the middleware server but not present at the mobile device may be downloaded.

In some implementations, the mobile device may initiate download of the form design information it does not possess and render corresponding custom dynamic forms. Upon display of a custom dynamic form, the mobile device may receive one or more values (i.e., responses) corresponding to a form element.

In some implementations, the mobile device may communicate the one or more values to the middleware server, thereby reporting the collected enterprise information. In some implementations, the mobile device may communicate the one or more values on-demand (i.e., by request). In some implementations, the mobile device may communicate the one or more values whenever a data connection is available. For example, the mobile device may associate a time and/or a geographic location with the one or more values. Thus, the mobile device may collect enterprise information in an “offline” mode where data connection signals are of poor quality or are unavailable.

In some implementations, the one or more values are communicated during the synchronization process. In some implementations, the one or more values, the form design information, and/or any portion of the foregoing are communicated between the mobile device and the middleware server using a stateless communication protocol such as Hyper Text Transfer Protocol (HTTP). In some implementations, HTTPS (secure HTTP) is used. By using a stateless communication protocol, data may be synchronized in a highly scalable manner.

In some implementations, the middleware server may communicate the enterprise information collected at the mobile device to an enterprise backend server. In some implementations, the enterprise information may be communicated to the enterprise backend server in a format particular to the backend server, thereby seamlessly integrating the enterprise information with the backend server.

### BRIEF DESCRIPTION OF THE DRAWINGS

FIG. 1 is a block diagram illustrating a system for communicating enterprise information between a mobile device and a backend enterprise server, according to various implementations of the invention.

FIG. 2 is a block diagram illustrating an example middleware server, according to various implementations of the invention.

FIG. 3 is a block diagram illustrating an agent configuring a mobile device to render, and collect enterprise information at, a custom dynamic form, according to various implementations of the invention.

FIG. 4A illustrates an example of a representation of a tree-like hierarchical options list, according to various implementations of the invention.

FIG. 4B illustrates an example of a linear efficient representation of a hierarchical options list, according to various implementations of the invention.

FIG. 5 illustrates an example of a process for communicating enterprise information between a mobile device and a backend enterprise server, according to various implementations of the invention.

FIG. 6 illustrates an example of a process for causing a custom dynamic form to be generated at a mobile device.

### DETAILED DESCRIPTION OF THE INVENTION

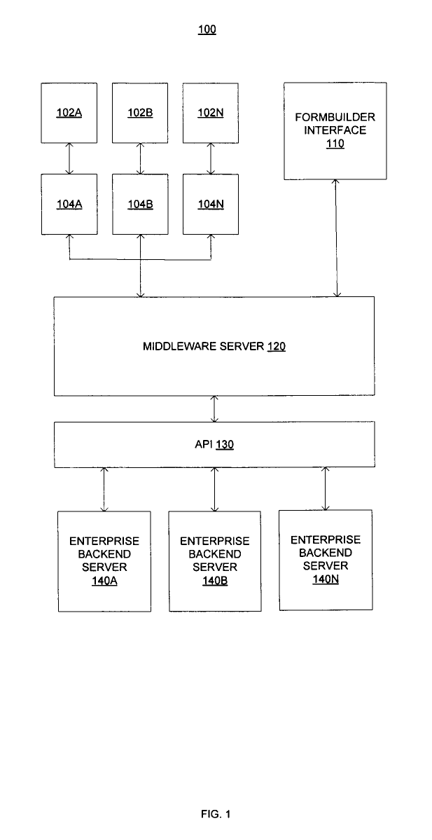

FIG. 1 is a block diagram illustrating a system 100 for communicating enterprise information between a mobile device 102 and a backend enterprise server 140, according to various implementations of the invention. System 100 includes a middleware server 120 communicably coupled to a mobile device 102 (illustrated in FIG. 1 as mobile device 102A, 102B, . . . , 102N) that renders one or more custom dynamic forms designed to collect the enterprise information. In some implementations, middleware server 120 is communicably coupled to a backend enterprise server 140 (illustrated in FIG. 1 as backend enterprise server 140A, 140B, . . . , 140N) that receives the enterprise information.

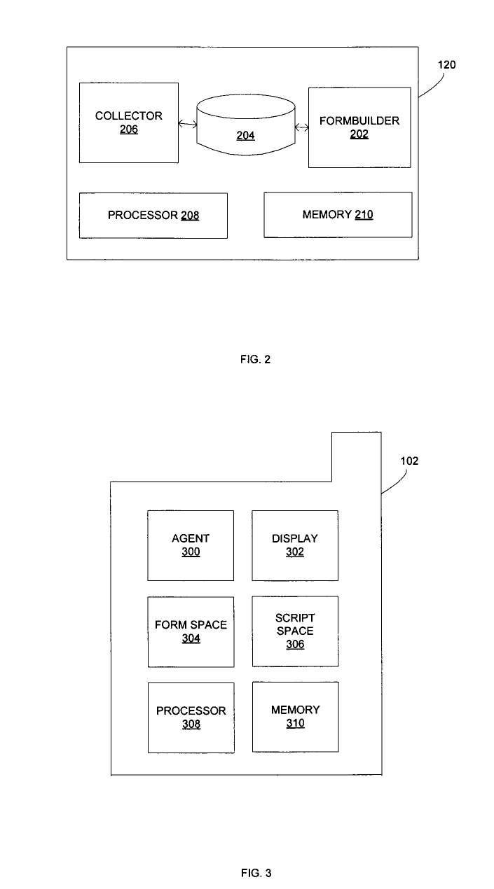

According to various implementations of the invention, middleware server 120 may generate a formbuilder interface 110, which enables a user to design the custom dynamic forms that collect the enterprise information. In some implementations, formbuilder interface 110 is a graphical user interface such as a website executing on or otherwise being rendered by a client computing device (not illustrated in FIG. 1) and/or other device configured to display formbuilder interface 110. Through formbuilder interface 110, middleware server 120 may receive form design information from a user “designing” the custom dynamic form, as discussed in further detail below with reference to FIG. 2.

In some implementations, middleware server 120 may receive a synchronization request from mobile device 102. The synchronization request may include a request to download form design information in order to render one or more custom dynamic forms by mobile device 102, upload one or more values from the one or more custom forms, and/or perform other synchronization functions such that middleware server 120 and mobile device 102 share information that one has that the other should have. In some implementations, in response to the synchronization request, middleware server 120 communicates the form design information to mobile device 102.

According to various implementations of the invention, mobile device 102 receives the form design information from middleware server 120 and efficiently renders the custom design form in a format that is native to mobile device 102 based on the form design information, as described in further detail below with reference to FIG. 3. In some implementations, an operator of mobile device 102 may input the enterprise information using the custom design form. For example, the operator may be a technician installing cable television, an inspector inspecting a construction site, and/or other individual or entity that inputs enterprise information using the custom design form.

According to various implementations of the invention, middleware server 120 may receive one or more values (i.e., enterprise information) for the form elements input by an operator interacting with the custom design form rendered by mobile device 102. In some implementations, each form element may be assigned a form element index that identifies the form element. In some implementations, the one or values may be received as part of a synchronization request and/or other communication. Upon receipt of the one or more values, middleware server 120 may communicate the one or more values to enterprise backend server 140.

According to various implementations of the invention, middleware server 120 uses an open data architecture to flexibly store various information (such as form design information, enterprise information collected at the custom dynamic forms, etc.) communicated between mobile device 102 and backend server 140. In this manner, different business needs of different enterprises may be accommodated without using a fixed architecture, such as fixed database schemas and tables (i.e., one-size-fits-all databases) common in existing systems.

According to various implementations of the invention, mobile device 102 may be a cellular phone, a smartphone, a personal digital assistant, a tablet device, and/or other computing device from a wide range of manufacturers that may display the custom dynamic forms disclosed herein. In other words, the custom dynamic forms may be executed on a variety of different types, vendors (such as wireless service plan carriers), and/or manufacturers of existing mobile devices, thereby providing an out-of-the-box solution for prompting, collecting, and/or reporting enterprise information using a wide range of mobile devices.

According to various implementations of the invention, middleware server 120 may communicate form design information and/or enterprise information to and from mobile device 102 via adaptor 104 (illustrated in FIG. 1 as adaptor 104A, 104B, . . . , 104N). In some implementations, adaptor 104 is hardware and/or instructions executing at mobile device 102 and/or middleware server 120. Adaptor 104 may convert the open architecture data to a format understood by mobile device 102, thereby enabling various types, vendors, and/or manufacturers of mobile computing devices to be used with various implementations of the invention.

In some implementations, adaptor 104 may convert the form design information into form elements that are native to mobile device 102. In other words, instead of communicating form design information to mobile device 102, adaptor 104 may communicate form elements particular to mobile device 102. Thus, adaptor 104 may generate form elements and/or the custom dynamic form in a format native to mobile device 102.

According to various implementations of the invention, backend enterprise server 140 may include any computing device configured to receive enterprise information from middleware server 120. For example, backend enterprise server 140 may include, for example, an SQL server, a webserver, a desktop computer, and/or other computing device implemented by an enterprise. Thus, different enterprises having different technology and different enterprise information collection needs are accommodated using various implementations of the invention disclosed herein.

According to various implementations of the invention, middleware server 120 may communicate with backend enterprise server 140 via an Application Programming Interface (illustrated in FIG. 1 as API 130). API 130 may convert the open data architecture used by middleware server 120 into a format understood by backend enterprise server 140 so that middleware server 120 may seamlessly integrate with different types of technologies. For example, API 130 may generate SQL statements based on enterprise information stored by middleware server 120. The generated SQL statements may be used to insert the enterprise information into a backend enterprise server 140 that includes an SQL server.

FIG. 2 is a block diagram illustrating an example middleware server 120, according to various implementations of the invention. In some implementations, middleware server 120 may include, among other things, a formbuilder 202, an open architecture database 204, a collector 206, a processor 208, and a memory 210.

In some implementations, formbuilder 202 generates formbuilder interface 110 (illustrated in FIG. 1). For example, in some implementations, formbuilder 202 includes a webserver configured to generate a webpage that displays formbuilder interface 110. In some implementations, formbuilder 202 may be used by various businesses to generate custom dynamic forms that collect enterprise information according to their particular needs. For example, a cable company, a government inspection agency, an auditing firm, and/or other individual or entity may use formbuilder 202 to design different custom dynamic forms according to their particular enterprise information requirements. In this manner, formbuilder 202 may provide an out-of-the-box data collection solution that may be used by different businesses to collect different enterprise information.

In some implementations, formbuilder 202 performs user credential validation by prompting for and receiving credentials for a user who is attempting to design and/or update a custom dynamic form using formbuilder interface 110. In this manner, formbuilder 202 may determine whether the user has access to generate a custom dynamic form, which types of custom dynamic forms the user may design, and/or perform other operations related to access rights of the user. In some implementations, user credential validation may include identifying a business associated with the user such that different businesses may use formbuilder 202 to generate forms specific to their respective enterprise information requirements.

For example, a manager at a cable company may login to design and/or update a custom dynamic form used by cable technicians to track service work. Formbuilder 202 may validate the manager's user credentials and recognize that the manager has access to design and/or update custom dynamic forms used by technicians. Formbuilder 202 may recognize that the manager is associated with the cable company, thereby allowing the manager to design and/or update only the custom dynamic forms associated with the cable company. On the other hand, a lead inspector at a government inspection agency may login to design and/or update a custom dynamic form used by inspectors to manage building code inspections. Formbuilder 202 may validate the lead inspector's credentials and associate the lead inspector with the government inspection agency, thereby allowing the lead inspector to design and/or update custom dynamic forms associated with the government inspection agency. Thus, different users of formbuilder 202 may generate different custom dynamic forms that collect enterprise information for their respective enterprises.

In some implementations, different users within the same business may have different permissions to access and/or otherwise design custom dynamic forms. For example, an accountant at the cable company may have permission to design and/or update custom accounting forms but may not have permission to design and/or update custom dynamic forms related to cable installation. In this manner, different departments within a business may design and/or update their own custom dynamic forms according to departmental or other needs.

According to various implementations of the invention, formbuilder 202 provides input areas for a user to provide form design information using formbuilder interface 110. The form design information may include one or more of a form element, metadata for the form element, dependency information for the form element, an executable script, an option list, sub-form information, and/or other information used to design the custom dynamic form. By enabling the user to input form design information that may include a wide range of information for generating the custom dynamic form, the content and behavior of the form may be controlled so that complex data and interrelationships between the data are efficiently conveyed to an operator of mobile device 102. In this manner, a wide variety of custom dynamic forms may be designed to efficiently prompt for and collect different enterprise information at mobile device 102.

In some implementations, the form element may be used to collect at least a portion of the enterprise information and/or may simply convey information to an operator of the custom dynamic form rendered by mobile device 102. For example, in some implementations, the form element may include a question and/or an input area where a value is to be entered by the operator of mobile device 102 who interacts with the custom dynamic form.

In some implementations, the question may include a literal question, a task to be completed, and/or other message relevant to collect or otherwise communicate enterprise information. In some implementations, the input area may include a text area, a button, a checkbox, an option list, a multimedia file or other file input (such as when a response to the question or task includes a video image, sound file, or other file), and/or other input function.

In some implementations, the form element may include a message, a graphic, or other communication intended to provide information to the operator of the custom dynamic form. For example, the form element may include a logo of the business that is collecting the enterprise information using the custom dynamic form.

By using formbuilder 202 to design a plurality of form elements for inclusion into the custom dynamic form, a user designing the custom dynamic form (or “form designer” as used interchangeably herein for convenience) may generate a robust set of questions and/or tasks to be completed. In some implementations, responses to the questions and/or tasks input by an operator of the custom dynamic form displayed by mobile device 102 represent the enterprise information that is to be collected. As such, formbuilder 202 enables the user of formbuilder interface 110 to design various questions and input areas to be incorporated into the custom dynamic form in order to collect the enterprise information. Thus, the custom dynamic form may be designed to collect different enterprise information according to particular needs of different businesses. In this manner, various implementations of the invention allow different businesses to use a single platform to collect different information according to their particular needs. For example, a cable television company may use various implementation of the invention to design forms that present customer information and collect installation information. On the other hand, a government inspection agency may use various implementations of the invention to present inspection checklists and collect information related to the inspection.

According to various implementations of the invention, the metadata may be used by a user designing the custom dynamic form to describe the form element. The metadata may include, for example, a location identifier that identifies a position or location within the custom dynamic form where the form element should appear; a type of the form element (such as whether the question and/or task is text, a file, an image, etc.); company information that identifies the business to which the form element belongs; options for responses; option lists; and/or other information that describes the form element.

In some implementations, the location identifier indicates a location in which to place the form element. For example, because a custom dynamic form may include several form elements that may span multiple pages in the display of mobile device 102, the form designer may specify a page or other location of a particular form element. In this manner, the form designer may flexibly control where on the custom dynamic form a given form element should appear.

In some implementations, company info may identify the business for which the form element is being used. Using the company info metadata, for example, form elements may be organized according to the business that created them.

In some implementations, options metadata may indicate various options available to respond to the form element. For example, a particular form element may be constrained to a number of pre-defined responses (such as “yes” or “no”) described by the options metadata.

In some implementations, option lists metadata may indicate one or more pre-defined option lists that may be used as a basis for the form element. In some implementations, each item of an option list may include a selectable response to a particular form element (such as, for example, “red”, “blue”, “white” in response to a “pick a favorite color” form element).

In some implementations, option lists metadata may indicate different form elements that should be displayed on the custom dynamic form based on context. For example, each item of an options list may correspond to a hospital room of a hospital that when selected causes the custom dynamic form to display another custom dynamic form related to the selected hospital room. Hospital rooms may be hierarchically organized by hospital, which may in turn be organized by county, which may in turn be organized by state. In some implementations, for example, the hospital rooms may be represented as an options list. Based on which state, county, or hospital is selected (i.e., the context), a list of hospital rooms may be displayed by the custom dynamic form.

In some implementations, because the option list (and other form design information) may be communicated to and locally stored by mobile device 102, dynamic custom forms are offline-enabled. In other words, an operator of mobile device 102 may interact with and input enterprise information using a custom dynamic form even where there is no data coverage. Thus, mobile device 102 may collect the enterprise information in an “offline mode.” In some implementations, the collected enterprise information may be communicated to middleware server 120 when data service is available, as described herein elsewhere.

According to various implementations of the invention, the option list may be indexed in order to facilitate efficient traversal and display of the option list. In some implementations, the option list may include several records, only a portion of which is actually displayed by mobile device 102. In these implementations, the option list index facilitates efficient traversal and identification of which items of the option list should be displayed.

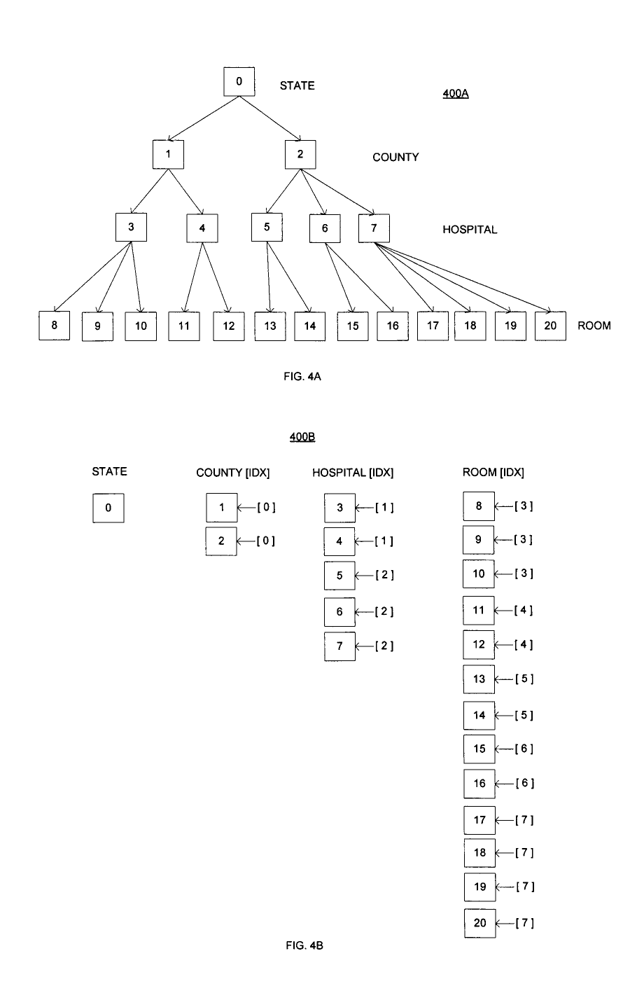

In some implementations, the option list index may be hierarchically arranged as illustrated in FIG. 4B. Instead of representing the hierarchical option list as a hierarchical tree with the first level at the top node of the tree as illustrated in FIG. 4A, the dynamic hierarchical option list may be indexed in a flat structure as illustrated in FIG. 4B. In some implementations, the index may be incorporated in various option lists described herein for efficient traversal.

According to various implementations of the invention, the form design information may include dependency information, which may describe when a particular value of a form element causes an action to be taken by the custom dynamic form, executable script (described below), and/or other component of mobile device 102. In some implementations, the dependency information may include a dependency map that uses the form element index for each form element in order to map dependencies from one form element to another. For example, if a form element having an index value of 3 depends upon a value of a form element having an index value of 2, then the dependency map may be represented as “2->3” (or “2” informs “3” of any changes to “2”). In this manner, dependencies between one form element to another form element (or many other form elements) may be communicated to mobile device 102.

In some implementations, the action to be taken may include, for example, causing an otherwise invisible form element (such as a hidden form element) to become visible, calculating a value based on two or more form elements, displaying a sub-form, and/or performing other actions. Thus, the form elements may be dynamic form elements. In some implementations, all form elements for a custom dynamic form may be communicated to mobile device 102 even though some form elements may be hidden form elements. In some implementations, the particular value of the form element may include a value outside of a threshold limit (such as when a user inputs a response to a question that exceeds or is below a certain threshold value). In some implementations, the particular value of the form element may be a non-null value (i.e., a user entering a response causes the action to be taken).

In some implementations, the form design information may include an executable script input by the user that is to be executed when the custom dynamic form is rendered and/or when a user is inputting enterprise information using the custom dynamic form. In some implementations, the executable script when executed causes an action to be performed by the custom dynamic form and/or mobile device 102. For example, as described above, a form element may be associated with a dependency such that a value of the form element causes the action to be performed. When the value is a particular value, then the executable script may be executed by the custom dynamic form and/or mobile device 102. In some implementations, the executable script may determine whether the action should be performed, define the action to be performed, and/or perform other functions as indicated by the form designer. In some implementations, the executable script includes an interpreted script that is compiled at runtime. In some implementations, in order to leverage the growing capability of mobile devices to access the Internet, the interpreted script is JAVASCRIPT. In some implementations, the interpreted script includes, for example, VBScript, PERL, PHP, and/or other interpreted code. In some implementations, the executable script includes pre-compiled executable code such as, for example, compiled C#, JAVA, and/or other pre-compiled code. In some implementations, a link may be input by the form designer that points to or otherwise references code and/or functions installed at mobile device 102 such as functions provided by agent 300.

Thus, according to various implementations of the invention, the form designer may input actual programming instructions that when executed at least partially controls the behavior of the custom dynamic form. In this manner, the form designer is provided with more flexibility and control than existing form design solutions that constrain the user to simple conditional operators (such as “<”, “>”, and so forth), thereby enabling a wide range of different form behavior according to particular needs. In some implementations, the open nature of allowing the form designer to enter an interpreted script allows a more robust handling of conditionals such as nesting conditionals, more types of conditionals, interrelationships between conditionals, and so forth.

According to various implementations of the invention, the form design information may include sub-form information. In some implementations, a sub-form is a form that is embedded in another form. In some implementations, a sub-form may include a form that was designed independently of the form into which the sub-form is embedded. In some implementations, the sub-form may be designed to be embedded in another form. In this manner, forms may be combined with one another and/or multiple layers of forms may be designed by designing sub-forms to be embedded into another form. In some implementations, a sub-form may be embedded in another sub-form, thereby producing a form having multiple levels of sub-forms. The number of levels of nesting (i.e., embedding) sub-forms into other forms or sub-forms may be adjusted according to particular needs, thereby providing flexible collection of various enterprise information.

According to various implementations of the invention, upon receiving the form design information, formbuilder 202 may generate one or more database tables to store the form design information in form database 204, which uses an open data architecture. The open data architecture provides flexible storage of the form design information. For example, whereas existing systems may be constrained by using pre-existing and fixed database tables/schemas to store information, various implementations of the invention generate (or otherwise create) database tables to store the form design information. In this manner, different business needs are accommodated without requiring use of fixed database tables to store the form design information. Instead, formbuilder 202 may generate one or more database tables tailored to store the form design information.

According to various implementations of the invention, form and sub-form relationships described above may be stored using open architecture database 204 using database pointers. For example, a form element may be identified by the form element index, which may be stored in a database table created by formbuilder 202 to store the form element. In some implementations, the form element is associated with a sub-form such that when the form element is rendered on a custom dynamic form, the sub-form is embedded within the custom dynamic form in a location occupied by the form element. The form element index may be a pointer to a form identifier that is associated with the sub-form. Thus, when the form designer indicates that the custom dynamic form should include a sub-form, formbuilder 202 may generate the appropriate database pointer. By allowing multiple levels of pointers, formbuilder 202 may enable multiple levels of embedded sub-forms, thereby allowing one or more cascades of sub-forms (where one sub-form points to another sub-form and so on).

According to various implementations of the invention, middleware server 120 may receive a request from mobile device 102 to receive one or more custom dynamic forms. In response to the request, collector 206 may identify mobile device 102 and/or an operator of mobile device 102 to determine which of the one or more custom dynamic forms (i.e., the form design information used to render the custom dynamic forms) is available for download by mobile device 102. In some implementations, middleware server 120 may notify mobile device 102 of the custom dynamic forms available for download by mobile device 102.

In some implementations, mobile device 102 may perform a synchronization operation where custom dynamic forms that are available at middleware server 120 but not present at mobile device 102 may be downloaded.

In some implementations, the synchronization operation and/or other communication of data between mobile device 102 and middleware server 120 may be communicated via a stateless communication protocol. The stateless communication protocol may include HTTPS, Short Messaging Service (SMS), and/or other stateless communication protocol. In some implementations, a first portion of the data (whether synchronization data or other communication) may be communicated via a first instance of a stateless communication protocol such as a first HTTPS request and a second portion of the data may be communicated via a second instance of a stateless communication protocol such as a second HTTPS request. In this manner, using pulses of communications to transmit the first and second portions of data, communication between middleware server 120 and mobile device 102 may be scaled because stateless communication protocols do not have the overhead of other communication protocols that maintain state. In other words, middleware server 120 may communicate with more mobile devices 102 using stateless communication protocols than using alternative communication protocols. As would be appreciated, middleware server 120 may communicate with mobile device 102 using other communication protocols when available, such as via a Wireless Internet connection, USB connection, and/or other known communication protocols that allow communication between mobile device 102 and middleware server 120.

Furthermore, in some implementations, mobile device 102 and/or middleware server 120 may segment data to be communicated into smaller increments. In these implementations, data communication between mobile device 102 and middleware server 120 may be enhanced because data may be transferred in increments as data service becomes available. This may be particularly advantageous where data service coverage is spotty and smaller data increments may be transferred more effectively than larger data files.

According to various implementations of the invention, processor 210 may include one or more processors that execute or otherwise perform the functions of middleware server 120 described herein. Memory 212 may store instructions that when executed on processor 210 execute or otherwise perform the functions of middleware server 120 described herein.

Although middleware server 120 is illustrated in FIG. 2 as an integrated unit performing both the functions of middleware server 120 and including open architecture database 204, the functions and/or open architecture database 204 may include various configurations as would be appreciated. For example, in some implementations as illustrated in FIG. 2, middleware server 120 may include a “shared” configuration, where various businesses share the function of middleware server 120 and/or open architecture database 204 with one another. In some implementations, middleware server 120 may include a “dedicated” configuration wherein at least one business has dedicated functions and/or a dedicated open architecture database 204 (not illustrated in FIG. 2). In some implementations, middleware server 120 may include a “hybrid” configuration wherein at least a portion of the functions and/or open architecture database 204 is shared at backend enterprise server 140 and middleware server 120 (not illustrated in FIG. 2). In some implementations, middleware server 120 may include an “on-premises” configuration wherein the entirety of middleware server 120 is installed at backend enterprise server 140 (not illustrated in FIG. 2).

FIG. 3 is a block diagram illustrating an agent 300 configuring mobile device 102 to render and collect enterprise information using a custom dynamic form, according to various implementations of the invention. In some implementations, agent 300 may execute at or otherwise control form space 304 and/or script space 306 when executed by processor 308. Memory 310 may store agent 300 for execution by processor 308. For instance, agent 300 may include instructions stored on memory 310, wherein the instructions when executed by processor 308 perform the functions of agent 300. In some implementations, form space 304 may include a form rendering engine native to mobile device 102. In some implementations, script space 306 may include programming interpreters and/or libraries that execute compiled code that are native to mobile device 102. Thus, in some implementations, agent 300 may use form engines and/or script environments native to mobile device 102. In some implementations, agent 300 includes or otherwise interfaces with adaptor 104 described above in relation to FIG. 1.

In some implementations, agent 300 may cause mobile device 102 to communicate with middleware server 120. Agent 300 may cause form space 304 to generate an interface to middleware server 120 to be displayed at a display 302 of mobile device 102. An operator of mobile device 102 may interact with the interface in order to provide login credentials.

In some implementations, upon successful login, agent 300 may cause mobile device 102 to request form design information for download from middleware server 120. In some implementations, agent 300 may cause mobile device 102 to initiate download of the form design information it does not possess and render corresponding custom dynamic forms. Thus, agent 300 may maintain a state of the custom dynamic forms stored at mobile device 102. In other words, agent 300 may keep track of form design information stored at mobile device 102. In some implementations, agent 300 may compare the form design information stored at mobile device 102 with form design information that is available in order to identify which information should be downloaded. In some implementations, multiple custom dynamic forms may be available, thereby serving as a workorder for the operator of mobile device 102, who may select one or more of the custom dynamic forms with which to interact. Upon display of a custom dynamic form, the operator of mobile device 102 may input one or more values (i.e., responses) at a form element.

In some implementations, agent 300 may cause mobile device 102 to communicate the one or more values to middleware server 120, thereby communicating the collected enterprise information. In some implementations, agent 300 may cause mobile device 102 to communicate the one or more values on-demand (i.e., by request). In some implementations, agent 300 may cause mobile device 102 to communicate the one or more values whenever a data connection is available. For example, agent 300 may associate a time and/or a geographic location with the one or more values. Thus, agent 300 may cause mobile device 102 to collect enterprise information in an “offline mode” where data connection signals are of poor quality or are unavailable, while maintaining when and where the one or more values were collected at mobile device 102. The offline mode may associate a time and/or location where the enterprise information was collected. In some implementations, upon connecting to middleware server 120 when data service is available, agent 300 may communicate the time and/or location along with the enterprise information.

In some implementations, the one or more values are communicated during a synchronization process. In some implementations, the one or more values, the form design information, and/or any portion of the foregoing are communicated between the mobile device and the middleware server using a stateless communication protocol such as HTTPS. By using a stateless communication protocol, data may be synchronized in a highly scalable manner.

In some implementations, form design information for a particular custom dynamic form may include a plurality of form elements that cannot be displayed by display 302 because of its limited screen size. Oftentimes, only a portion of the plurality of form elements are to be displayed at any given time. For example, some form elements may be hidden from view unless activated while other form elements are visible. Such layering, or dynamic form elements, may provide an efficient method of displaying some form elements but not others unless needed. In some implementations, dynamic form elements may be achieved using dependency information from middleware server 120. For example, a dependency map may specify that a particular value of a first form element causes one or more second form elements that were previously hidden to be dynamically displayed. In some implementations, a custom dynamic form may not have any such dependency information. In these implementations, by determining upfront whether dependencies exist via the dependency information (or lack thereof), agent 300 may quickly render the custom dynamic form without checking for dependencies, thereby improving the efficiency of rendering the form compared to if agent 300 checked each form element for dependencies. By receiving the dependency information from middleware server 120, agent 300 may efficiently manage display of the form elements.

In some implementations, agent 300 may receive an executable script from middleware server 120. The executable script may be directly executable at script space 306 of mobile device 102. In other words, the executable script may include executable programming instructions written in an interpreted programming language or a compiled programming language. In this manner, agent 300 may cause executable script to execute directly at script space 306 when indicated. For example, in some implementations, a first form element may depend on a value entered at a second form element (i.e., a response, entered by the operator of mobile device 102, to the second form element). Depending on the value of the second form element, a value of the first form element may be determined by the executable script. For example, the value of the first form element may be a sum of the second form element and another value. As would be appreciated, the executable script may perform other functions such as making the first form element visible, performing more complex mathematics and/or performing other functions. Thus, form behavior may be directly controlled by the form designer by inputting the executable script that is executed at the custom dynamic form.

In some implementations, agent 300 may receive a dynamic hierarchical option list according to the representation illustrated in FIG. 4B. By receiving this representation (as opposed to the representation illustrated in FIG. 4A), agent 300 may efficiently traverse multiple levels of hierarchical options lists, thereby quickly rendering custom dynamic forms having a complex hierarchical structure.

FIG. 4A illustrates an example of a tree-like representation 400A of a hierarchical options list, according to various implementations of the invention. FIG. 4A illustrates an example of hierarchically organizing an option list that represents hospital rooms organized by a top level state to a county level to a hospital level and to the bottom level rooms. According to this representation, in order to traverse the hierarchical options list, such as when the operator of mobile device 102 selects “county 2” to view hospitals corresponding to “county 2”, a top-down tree walk is performed and continues until “county 1” is reached. In a hierarchical option list that includes multiple levels with a plurality of nodes at each level, such traversal may be inefficient.

FIG. 4B illustrates an example of an more efficient representation 400B of a hierarchical options list, according to various implementations of the invention. FIG. 4B illustrates the hospital room hierarchy illustrated in FIG. 4A but organized in a flat hierarchy with reverse indexing. By using the flat hierarchy with indexing, the appropriate level is immediately selected. For example, when the operator of mobile device 102 selects “county 2” to view hospitals corresponding to “county 2”, the index of “2” immediately yields hospitals 5, 6, and 7, thereby eliminating the need to perform a top-down tree walk as would be required based on representation 400A.

FIG. 5 illustrates an example of a process 500 for communicating enterprise information between a mobile device and a backend enterprise server, according to various implementations of the invention. The various processing operations depicted in the flow diagram of FIG. 5 (and in the other drawing figures) are described in greater detail herein. The described operations for a flow diagram may be accomplished using some or all of the system components described in detail above and, in some implementations, various operations may be performed in different sequences. According to various implementations of the invention, additional operations may be performed along with some or all of the operations shown in the depicted flow diagrams. In yet other implementations, one or more operations may be performed simultaneously. Accordingly, the operations as illustrated (and described in greater detail below) are examples by nature and, as such, should not be viewed as limiting.

In an operation 502, a formbuilder interface may be generated. The formbuilder interface allows a form designer to design a custom dynamic form that collects enterprise information related to a business. For example, the form designer may be an employee of a medical organization that inspects its hospital rooms. The form designer may design a custom dynamic form that collects hospital (i.e., “enterprise”) information for each hospital room. In an operation 504, form design information may be received. The form design information may include one or more form elements that may be displayed on the custom dynamic form, one or more executable scripts that control the behavior of at least a portion of the custom dynamic form, dependency information that describes one or more dependencies between different form elements, options lists, and/or other information related to generating or otherwise defining the custom dynamic form. The form design information may define different types of hospital information to collect and how to display the custom dynamic form, among other information related to the data collection process.

In an operation 506, the form design information may be communicated to a mobile device so that the mobile device may render the custom dynamic form based on the form design information. The operator of the mobile device may interact with the custom dynamic form to input enterprise information. For instance, the operator may be an employee of the hospital inspecting various rooms. As the employee begins each room inspection, the employee may select the appropriate room, which may cause the mobile device to display a sub-form, which is itself a custom dynamic form embedded in the parent custom dynamic form.

In an operation 508, values entered by the employee using the custom dynamic form may be received. In an operation 510, the received values may be communicated to an enterprise backend server. In this manner, a custom dynamic form is generated, communicated to a mobile device, and collects enterprise information from an operator of the mobile device.

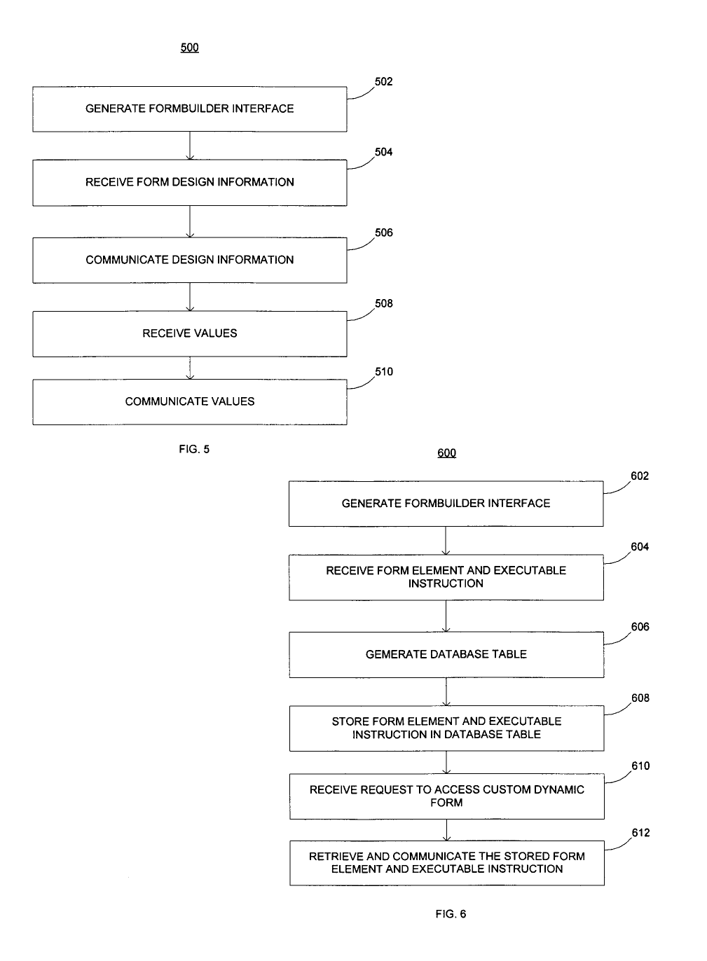

FIG. 6 illustrates an example of a process 600 for causing a custom dynamic form to be generated at a mobile device. In an operation 602, a formbuilder interface may be generated. In an operation 604, one or more form elements and an executable instruction may be received. In an operation 606, upon receipt, a database table may be created. In an operation 608, the one or more form elements and executable instruction may be stored in the created database table. In an operation 610, a request to access the custom dynamic form may be received. In response to the request, in an operation 612, the stored form element and the executable instruction may be retrieved and communicated.

Implementations of the invention may be made in hardware, firmware, software, or any suitable combination thereof. Implementations of the invention may also be implemented as instructions stored on a machine-readable medium, which may be read and executed by one or more processors. A tangible machine-readable medium may include any mechanism for storing or transmitting information in a form readable by a machine (e.g., a computing device). For example, a tangible machine-readable storage medium may include read only memory, random access memory, magnetic disk storage media, optical storage media, flash memory devices, and other tangible storage media. Intangible machine-readable transmission media may include intangible forms of propagated signals, such as carrier waves, infrared signals, digital signals, and other intangible transmission media. Further, firmware, software, routines, or instructions may be described in the above disclosure in terms of specific exemplary implementations of the invention, and performing certain actions. However, it will be apparent that such descriptions are merely for convenience and that such actions in fact result from computing devices, processors, controllers, or other devices executing the firmware, software, routines, or instructions.

Implementations of the invention may be described as including a particular feature, structure, or characteristic, but every aspect or implementation may not necessarily include the particular feature, structure, or characteristic. Further, when a particular feature, structure, or characteristic is described in connection with an aspect or implementation, it will be understood that such feature, structure, or characteristic may be included in connection with other implementations, whether or not explicitly described. Thus, various changes and modifications may be made to the provided description without departing from the scope or spirit of the invention. As such, the specification and drawings should be regarded as exemplary only, and the scope of the invention to be determined solely by the appended claims.

What is claimed is:

1. A method for communicating, by a middleware server, enterprise information between a mobile device and an enterprise backend server using a custom dynamic form displayed at the mobile device, the method comprising:
generating, by the middleware server, a formbuilder interface that is used to design the custom dynamic form;
receiving, by the middleware server from the formbuilder interface, form design information that causes the custom dynamic form to be displayed, wherein the form design information includes a plurality of form elements and an executable instruction,
wherein a value of the first one of the plurality of form elements causes an action to be taken by the form, and wherein the executable instruction when executed causes the action to be taken;
communicating, by the middleware server to the mobile device, the plurality of form elements and the executable instruction;
receiving, from the custom dynamic form, a plurality of values each input at respective ones of the plurality of form elements,
wherein the plurality of values include the enterprise information, and wherein the plurality of form elements includes at least one value affected by the action to be taken by the form; and
communicating the plurality of values to the enterprise backend server.

2. The method of claim 1, wherein at least one of the plurality of form elements includes a link to a sub-form within the custom dynamic form, wherein selection of the link causes the sub-form to be displayed within the custom dynamic form.

3. The method of claim 1, further comprising:
storing the plurality of values in a common data format, wherein said communicating the plurality of values further comprises converting the common data format to a particular data format used by the enterprise backend server and communicating the enterprise information using the particular data format.

4. The method of claim 1, further comprising:
generating a dedicated database table configured to store only the plurality of form elements and the executable instruction used to render the custom dynamic form; and
storing the plurality of form elements and the executable instruction using the dedicated database table.

5. The method of claim 4, further comprising:
receiving a second plurality of form elements and a second executable instruction for a second custom dynamic form different from the custom dynamic form;
generating a second dedicated database table configured to store only the second plurality of form elements and the second executable instruction used to render the second custom dynamic form; and
storing the second plurality of form elements using the second dedicated database table.

6. The method of claim 5, further comprising:
receiving one or more values from each of a plurality of different custom dynamic forms, wherein at least two of the one or more values are received using different stateless communication protocols.

7. A method for designing a custom dynamic form used to collect enterprise information at a mobile device, wherein the custom dynamic form is based on a plurality of form elements input at a formbuilder interface, the method comprising:
generating, by the middleware server, a formbuilder interface that enables a user to design the custom dynamic form;
receiving, from the formbuilder interface, a first form element and an executable instruction associated with the first form element, wherein a value of the first form element causes an action to be taken by the form, and wherein the executable instruction when executed causes the action to be taken;
generating at least one database table for the first form element and the executable instruction;
storing the first form element and the executable instruction in the generated at least one database table;
receiving a request, from the mobile device, to access the custom dynamic form; and
retrieving and communicating the stored first form element and the executable instruction to the mobile device in response to the request.

8. The method of claim 7, wherein the plurality of form elements includes a second form element dependent on the first form element, and wherein the action to be taken includes causing the second form element to be displayed on the form depending upon the value of the first form element.

9. The method of claim 7, further comprising:
receiving, from the custom dynamic form, a first input value for the first form element; and
communicating, via a stateless communication protocol, the first input value to a backend server.

10. The method of claim 9, further comprising:
receiving, from a backend server communicably coupled to the middleware server, information based on the first input value; and
communicating, by the middleware server, a second form based on the received information.

11. The method of claim 7, wherein the executable instruction includes an interpreted script or a compiled script.

12. The method of claim 11, wherein the executable instruction includes an interpreted script, the interpreted script including JAVASCRIPT.

13. The method of claim 7, the method further comprising:
communicating a second form element associated with a second dynamic custom form, wherein the action to be taken includes displaying the second dynamic custom form.

14. A system for communicating enterprise information between a mobile device and an enterprise backend server using a custom dynamic form displayed at the mobile device, the system comprising:
a middleware server that includes at least one processor configured to:
generate a formbuilder interface that is used to design the custom dynamic form;
receive from the formbuilder interface, form design information that causes the custom dynamic form to be displayed, wherein the form design information includes a plurality of form elements and an executable instruction,
wherein a value of the first one of the plurality of form elements causes an action to be taken by the form, and wherein the executable instruction when executed causes the action to be taken;
communicate to the mobile device the plurality of form elements and the executable instruction;
receive a plurality of values each input at respective ones of the plurality of form elements,
wherein the plurality of values include the enterprise information, and wherein the plurality of form elements includes at least one value affected by the action to be taken by the form; and
communicate the plurality of values to the enterprise backend server.

15. The system of claim 14, wherein at least one of the plurality of form elements includes a link to a sub-form within the custom dynamic form, wherein selection of the link causes the sub-form to be displayed within the custom dynamic form.

16. The system of claim 14, further comprising:
an open architecture database,
wherein the middleware server is further configured to store the plurality of values in a common data format at the open architecture database, wherein said communication of the plurality of values further comprises conversion of the common data format to a particular data format used by the enterprise backend server and communication of the enterprise information using the particular data format.

17. The system of claim 14, further comprising:
an open architecture database,
wherein the middleware server further configured to:
generate a dedicated database table at the open architecture database, wherein the dedicated database table is configured to store only the plurality of form elements and the executable instruction used to render the custom dynamic form; and
store the plurality of form elements and the executable instruction using the dedicated database table.

18. The system of claim 17, wherein the middleware server is further configured to:
receive a second plurality of form elements and a second executable instruction for a second custom dynamic form different from the custom dynamic form;
generate a second dedicated database table at the open architecture database, wherein the second dedicated database table is configured to store only the second plurality of form elements and the second executable instruction used to render the second custom dynamic form; and
store the second plurality of form elements using the second dedicated database table.

19. The system of claim 18, wherein the middleware server is further configured to:
receive one or more values from each of a plurality of different custom dynamic forms, wherein at least two of the one or more values are received using different stateless communication protocols.

20. A system for designing a custom dynamic form used to collect enterprise information at a mobile device, wherein the custom dynamic form is based on a plurality of form elements input at a formbuilder interface, the system comprising:
a middleware server that includes at least one processor configured to:
generate a formbuilder interface that enables a user to design the custom dynamic form;
receive, from the formbuilder interface, a first form element and an executable instruction associated with the first form element, wherein a value of the first form element causes an action to be taken by the form, and wherein the executable instruction when executed causes the action to be taken;
generate at least one database table for the first form element and the executable instruction;
store the first form element and the executable instruction in the generated at least one database table;
receive a request, from the mobile device, to access the custom dynamic form; and
retrieve and communicating the stored first form element and the executable instruction to the mobile device in response to the request.

21. The system of claim 20, wherein the plurality of form elements includes a second form element dependent on the first form element, and wherein the action to be taken includes causing the second form element to be displayed on the custom dynamic form depending upon the value of the first form element.

22. The system of claim 20, the middleware server further configured to:
receive, from the custom dynamic form, a first input value for the first form element; and
communicate, via a stateless communication protocol, the first input value to a backend server.

23. The system of claim 22, the middleware server further configured to:
receive, from a backend server communicably coupled to the middleware server, information based on the first input value; and
communicate a second form based on the received information.

24. The system of claim 20, wherein the executable instruction includes an interpreted script or a compiled script.

25. The system of claim 24, wherein the executable instruction includes an interpreted script, the interpreted script including JAVASCRIPT.

26. The system of claim 20, the middleware server further configured to:
communicate a second form element associated with a second dynamic custom form, wherein the action to be taken includes displaying the second dynamic custom form.

27. A method of collecting enterprise information at a mobile device that includes downloaded form design information used to generate custom dynamic forms for collecting the enterprise information, the method comprising:
receiving, from a middleware server, an indication of available form design information, wherein the form design information includes a plurality of form elements and an executable instruction;
comparing the available form design information with the downloaded form design information;
determining, at the mobile device, missing form design information based on the comparison;
downloading, from the middleware server, the missing form design information, wherein the missing form design information is included with the downloaded form design information after download;
rendering, at the mobile device, a custom dynamic form based on the downloaded form design information, the custom dynamic form using a native format of the mobile device;
receiving, at the mobile device, at least a portion of the enterprise information via the plurality of form elements of the custom dynamic form; and
communicating the at least a portion of the enterprise information to the middleware server.

28. The method of claim 27, wherein the at least a portion of the enterprise information is received in an offline mode, and wherein the at least a portion of the enterprise information is communicated to the middleware server when data service is available.

29. The method of claim 27, wherein the plurality of form elements includes a first form element, a second form element dependent on the first form element, and an executable instruction associated with the first form element, wherein a value of the first form element causes an action related to the second form element to be taken by the form, and wherein the executable instruction when executed causes the action to be taken.

30. A computer readable medium having stored thereon instructions for collecting enterprise information at a mobile device that includes downloaded form design information used to generate custom dynamic forms for collecting the enterprise information, the instructions when executed by one or more processors configure the one or more processors to:
receive, from a middleware server, an indication of available form design information, wherein the form design information includes a plurality of form elements and an executable instruction;
compare the available form design information with the downloaded form design information;
determine, at the mobile device, missing form design information based on the comparison;
download, from the middleware server, the missing form design information, wherein the missing form design information is included with the downloaded form design information after download;
render, at the mobile device, a custom dynamic form based on the downloaded form design information, the custom dynamic form using a native format of the mobile device;
receive, at the mobile device, at least a portion of the enterprise information via the plurality of form elements of the custom dynamic form; and
communicate the at least a portion of the enterprise information to the middleware server.

31. The computer readable medium of claim 30, wherein the at least a portion of the enterprise information is received in an offline mode, and wherein the at least a portion of the enterprise information is communicated to the middleware server when data service is available.

32. The computer readable medium of claim 30, wherein the plurality of form elements includes a first form element, a second form element dependent on the first form element, and an executable instruction associated with the first form element, wherein a value of the first form element causes an action related to the second form element to be taken by the form, and wherein the executable instruction when executed causes the action to be taken.
